(19) United States
(12) Patent Application Publication
(10) Pub. No.: US 2010/0245363 A1
(43) Pub. Date: Sep. 30, 2010

(54) METHOD OF GENERATING A TEXT ON A HANDHELD DEVICE AND A HANDHELD DEVICE

(75) Inventor: Søren Borup Jensen, Struer (DK)

Correspondence Address: HARNESS, DICKEY & PIERCE, P.L.C., P.O. BOX 8910, RESTON, VA, 20195, US

(73) Assignee: BANG & OLUFSEN A/S, Struer (DK)

(21) Appl. No.: 12/733,532

(22) PCT Filed: Sep. 11, 2008
(86) PCT No.: PCT/EP2008/062072

§ 371 Date: Mar. 5, 2010

Related U.S. Application Data
(60) Provisional application No. 60/960,076, filed on Sep. 14, 2007.

(51) Int. Cl. G06T 11/00

(52) U.S. Cl. 345/467

(57) ABSTRACT

A method and a system for generating a text on a handheld device having a touch sensitive display displaying in a first area any generated text and in another area proposed symbols/letters/words/characters for use in the first area, where touching the display alters between navigating in the text of the first area and selecting/highlighting one or more of the proposed symbols/letters/words/characters of the second area.

The present invention relates to improvements in devices comprising touch pads and especially for entering text into portable devices such as for texting/SMS or generating e-mails.

In a first aspect, the invention relates to a method of generating a text on a handheld device having:
an element for identifying or receiving a movement along a closed curve, and
a touch sensitive display/monitor for providing information to a user, the method comprising:
1. displaying, on a first area of the display/monitor, any generated text,
2. displaying, on a second area separate from the first area, one or more proposed symbols/letters/words/characters for use in the first area,
3. upon detection of a touch of the touch sensitive display/monitor, altering between:
   a. a first mode, wherein an identified/received movement causes navigation in the generated text in the first area, and
   b. a second mode, wherein an identified/received movement causes one or more of the proposed symbols/letters/words/characters of the second area to be sequentially highlighted.

In the present context, a handheld device may be a mobile telephone/cell phone, a DECT telephone, a calendar, media player or any portable element adapted to combine one or more of these functions with other operations, such as making telephone calls, playing games, position determination (GPS capability), surfing the WWW, or the like.

In the present context, navigation in the generated text and the proposed words/letters etc. is performed by the user generating a movement along the closed curve. The closed curve has the advantage that infinite scrolling may be performed without having to reverse the direction or e.g. move a scrolling element (as would be the situation if a scrolling brought a mouse to the edge of a table, whereby repositioning of the mouse would be required to continue the scrolling). This navigation may be the determination of a position, such as when using a cursor, of a position between words or characters for introduction or removal of words/letters/numbers/symbols. Also, words, letters or the like may be highlighted, such as for replacement or deletion.

This movement may be performed by the user operating a movable, such as rotatable, element a part of which then moves along the closed curve, or the user may operate e.g. a touch pad along a closed curve, or the movement of the user may be assumed to be along a closed curve and be determined in that context.

Touch sensitive displays/monitors are well-known and often used in portable equipment. The actual display/monitor may be touch sensitive, or a touch sensitive overlay may be provided to have a standard display become touch sensitive. A number of display types exist, and the touch sensitive operation may be based on a number of technologies, such as capacitance, resistance, or using optical means. Naturally, the overall functionality may be provided using one or more touch sensitive displays/monitors.

In this context, the different areas need not have fixed positions on the display, nor do they need to have fixed sizes. These areas may be altered if desired or required, such as by the amount of text/proposals desired illustrated at any one time.

As is usual when generating a text, a not-finished text will comprise a number of words and/or signs/letters, and a next word normally is in the process of being generated or identified. At the beginning, no text is defined, and when done, the text will be ready for whatever operation is desired (sending the text as an SMS/e-mail, interpreting the text as an instruction which may be carried out or the like).

In the present context, the sequential highlighting may be a scrolling, wherein, sequentially, the individual elements are highlighted. In this context, highlighting is any manner of making an element stand out in relation to other elements. Thus, highlighting may be the changing of a font, size, color, underlining, outlining, background or the like of the actual element or of the other elements in order for a user to be aware which element is highlighted.

As is standard on e.g. mobile telephones when generating a text, a number of letters are proposed, normally by activating touch buttons or a keyboard. These proposals are then provided in the second area (even though they need not all be present in the second area at the same time). In addition, a number of words may also be proposed by using a dictionary.

These proposals may be used when generating a text such as during entering of letters for a next word or may be used when altering/correcting the already generated text if e.g. a spelling error has occurred.

Thus, the dictionary or processor may be aware of the word being generated (the last complete or partial word in the generated text) or a word e.g. highlighted in the generated text, and provide other proposals based on the rules of the actual dictionary, such as the known T9 dictionary.

Touching the touch display will toggle between navigating in the elements of the second area—such as for selecting what to enter into the generated text, and the navigation in the generated text so as to determine where in the generated text to e.g. enter more proposals or corrections (such as deleting a letter/word/symbol or the like).

In one embodiment, the method further comprises the step of a user entering an instruction to the effect that one or more highlighted symbols/letters/words/characters in the second area is/are added to the generated text of the first area. This addition may be at a predetermined position (such as a position obtained by navigation in the generated text) or in order to replace a highlighted part of the generated text. This instruction may be any type of instruction entering, such as the pushing of a push button, touching the touch display in a particular position, the providing of visual or audio instructions or the like.

In another embodiment, step 3 comprises detecting a touch in any of the first and second areas. Alternatively, it may be required to touch the display in another defined area in order to facilitate the toggling. Also, it may be required to touch the first area to toggle between navigation in the second area and navigation in the first area.

In another embodiment, step 3, a, further comprises highlighting one or more words/symbols/letters/characters in the generated text and altering the generated text by altering the highlighted words/symbols/letters/characters. An alteration may be a deletion of a word/symbol/letter/number, the replacement thereof, an addition thereto, or the replacement of one word or one or more letters with a word, such as a word from a dictionary.

In yet another embodiment, the monitor/display comprises a third area, and wherein the method further comprises detecting a touch of the third area and altering one or more of the proposed symbols/letters/words/characters of the second area. Thus, this area may be used for toggling between capital letters and small letters, symbols, numbers, alphabets, proposed words from a dictionary, or the like.

Also, an embodiment relates to one where the display/monitor comprises an additional area and wherein the method further comprises:
comparing a latest added part of the generated text to words of a dictionary and proposing one or more words from the dictionary relating to the latest added part, and
detecting a touch of the additional area and transmitting the generated text to a selected recipient only if the comparing step proposes less than two words.

The latest added part of the generated text may be a full word or a part of a word and normally is the last part, in the reading direction, of the text and/or the latest added part. This part is analyzed and one or more proposals are given in order to facilitate fast generation of the text.

The transmission of the generated text may be as an SMS, e-mail or any other manner of transmitting text.

If the comparing step proposes less than two words, the generated text is unambiguous and may be transmitted. If two or more words are proposed, the user may be required to select one or enter additional parts of the actual word in order to have the comparing step remove proposals that are no longer relevant. Naturally, entering a complete word which is not present in the dictionary may allow the user to store the word in the dictionary.

In general, one or more proposed words may be provided in the first area so as to replace a latest added part of the generated text. Thus, instead of providing these in other areas of the display, a proposed word is presented at the position of the generated text. If more proposals are available, the user may toggle between these, such as using the movement along the closed curve. Finally, the user may select a proposal in any desired manner, such as by pushing a push button or tapping the display.

In another aspect, the invention relates to a handheld device having:
an element for identifying or receiving a movement along a closed curve,
a touch sensitive display/monitor for providing information to a user, and
a processor adapted to:
1. receive signals from the identifying/receiving element and the display/monitor,
2. have the display/monitor display, on a first area thereof, any generated text,
3. have the display/monitor display, on a second area thereof separate from the first area, one or more proposed symbols/letters/words/characters for use in the first area,
4. upon detection of a touch of the touch sensitive display/monitor, alter between:
   a. a first mode, wherein an identified/received movement causes navigation in the generated text in the first area, and
   b. a second mode, wherein an identified/received movement causes one or more of the proposed symbols/letters/words/characters of the second area to be sequentially highlighted.

As indicated above, the element for identifying or receiving the movement may comprise a movable element at least a part of which moves along the curve. An example of an element of this type is a rotatable element, the rotation of which is determined or identified by relevant means (opto couplers, accelerometer, potentiometer, optical, magnetic, resistive, inductive means or the like).

Alternatively, the movement may be of a part of a user along a surface of a touch pad.

The closed curve has the advantage that scrolling may be performed endlessly. Naturally, the movement need not be along the full closed curve but may be only a part thereof (such as a part of a circle).

A touch sensitive display is a display adapted to provide visual information to a user (monochrome or in color), and may be based on any known technology (LCD, LED, OLED, CRT, or the like). The touch sensitivity may be built into the display or may be provided subsequently, such as by providing a touch sensitive layer/element on the display. Touch sensitivity may be obtained using optical, resistive, inductive, magnetic, or the like, technologies as are widely known.

The display may be formed of any number of displays, and the areas may or may not be defined by boundaries of the displays. In addition, the areas need not be fixed in size or position, as it may be desired to alter these depending on the actual operation and the amount of information desired provided in an area.

The processor may be formed of one or more individual processors and may be hardwired and/or controlled by software.

The individual modes of the processor may be selectable by the user, and the processor may allow the user to perform other tasks than entering text, such as making telephone calls, experiencing events (such as viewing video or listening to music), determining a position (GPS capability), playing games, surfing the WWW, or the like.

The two modes normally would form part of one operation which is the text entering, where the user easily changes between scrolling/navigating in the already generated text (if any has been generated at this stage) and scrolling/navigating in the proposed words/letters/symbols or the like.

In one embodiment, the processor is additionally adapted to, upon receipt of an instruction, add one or more highlighted symbols/letters/words/characters in the second area to the generated text of the first area, such as at a predetermined position (which may have been determined by navigation in the first mode). In this manner, more text may be generated, or the already generated text may be improved.

In another embodiment, step 4 comprises detecting a touch in any of the first and second areas. Alternatively, only a single of the areas may be used, such as for starting the mode of scrolling in that particular area.

In yet another embodiment, step 4, a, further comprises highlighting one or more words/symbols/letters/characters in the generated text and altering the generated text by altering the highlighted words/symbols/letters/characters in the first area. As mentioned above, parts of the already generated text may be highlighted, as is usual in word processing software for computers, and this text may be deleted, replaced, or proposals for words from a dictionary may be made and selected.

In another embodiment, the monitor/display comprises a third area, and wherein the processor is further adapted to detect a touch of the third area and alter one or more of the proposed symbols/letters/words/characters of the second area. This may be a toggling between capital letters, small letters, numbers, symbols, other alphabets, dictionary, or the like.

Also, the display/monitor may comprise an additional area and the processor may be adapted to:
compare a latest added part of the generated text to words of a dictionary and proposing one or more words from the dictionary relating to the latest added part, and
upon detecting a touch of the additional area, transmit the generated text to a selected recipient only if the comparing step proposes less than two words.

As mentioned above, the latest added part may be a part of a word or a whole word. Normally, it is positioned at the end of the generated text in the reading direction of the alphabet in question and/or is the latest added part of the generated text.

As is known from mobile telephones, a dictionary such as T9 may be used for proposing complete words from event parts of words entered.

However, it is desired in this embodiment that the text is not transmitted until the text is unambiguous, which means that the user has selected a proposed word or a sufficient part of a word has been entered to the effect that the dictionary has no other proposals.

In addition, in general, the processor may be adapted to provide one or more proposed words in the first area so as to replace a latest added part of the generated text. This is an alternative to providing the proposals in another area where the user has to select a word to have it introduced in the generated text. If more proposals exist, the user may toggle between these, such as by using the movement along the curve.

In a third aspect, the invention relates to a method of operating a device comprising a touch sensitive display, the method comprising:
defining one or more active areas on the display, each area being correlated to an operation of the device,
determining a first touch of an active area and highlighting the area,
determining an instruction from a user and carrying out the operation correlated to the highlighted area.

The present touch sensitive display may be as that described further above.

Now, a first touch may highlight an area or information presented in the area. Again, highlighting may be any manner of illustrating to a user that this area or the information therein is different from other areas with other information.

The instruction may be any type of instruction, such as the starting or selection of a particular manner of operation (make a telephone call, listen to music, view video, play a game, surf the WWW, start a GPS procedure, view a folder, open a folder, add a highlighted word/letter/number/symbol to a generated text, replace text with the highlighted text, or the like).

In one embodiment, the first touch is a touch with an exerted first force toward the display, and the instruction is a second touch of the display exerted with a second force, which exceeds the first force. In this manner, a new first touch, as would be desirable if the first highlighted area was not that desired, may be separated from a second touch which acknowledges the selection of the highlighted area. In this situation, as the second touch is characterized by the force, the second touch may be made at any position on the display. Preferably, the first and second forces are recognized by one force being below a predetermined force limit and the other being above. Thus, by comparing the force to the limit, it may be determined whether the force exerted is a first or a second force. It may, naturally, be required to make this within a certain area, such as the same area, for other reasons, such as if a hard touch at other positions would bring about other effects.

Force sensitivity may be obtained in a number of manners, as will be made clear further below.

In another embodiment, the instruction is a second touch of the display simultaneously to the user entering additional information. Thus, the user may operate other input means at the same time in order to acknowledge the highlighted area. As mentioned above, this second touch may be made at any position of the display, as it is characterized by the additional information, unless a particular position is required for other reasons. This additional information may be input by the user operating other input means, such as a push button or the like.

Alternatively, multiple touches, such as with a predetermined timing relationship (e.g. double click) may be taken as the second touch and the additional information. In that regard, the “simultaneous” may be within a predetermined max time interval.

A final aspect of the invention relates to a device comprising a touch sensitive display, the device comprising:
an element for defining one or more active areas on the display, each area being correlated to an operation of the device,
a first element for determining a first touch of an active area and for highlighting the area,
a second element for determining an instruction from a user and carrying out the operation correlated to the highlighted area.

Naturally, the touch sensitive display may be as that mentioned further above.

In one embodiment, the first element is adapted to identify as the first touch a touch with an exerted first force, such as a force above or below a predetermined limit, toward the display, and wherein the second element is adapted to identify as the instruction a second touch of the display exerted with a second force, such as a force below or above the predetermined limit, which exceeds the first force. Multiple manners of rendering a display touch/force sensitive exist.

In another embodiment, the second element is adapted to identify as the instruction a second touch of the display simultaneously to the user entering additional information. Then, the user may operate other input means, such as a push button, or may provide an additional touch within a maximum time interval from the first second touch.

In the following, preferred embodiments will be described with reference to the drawing, wherein:

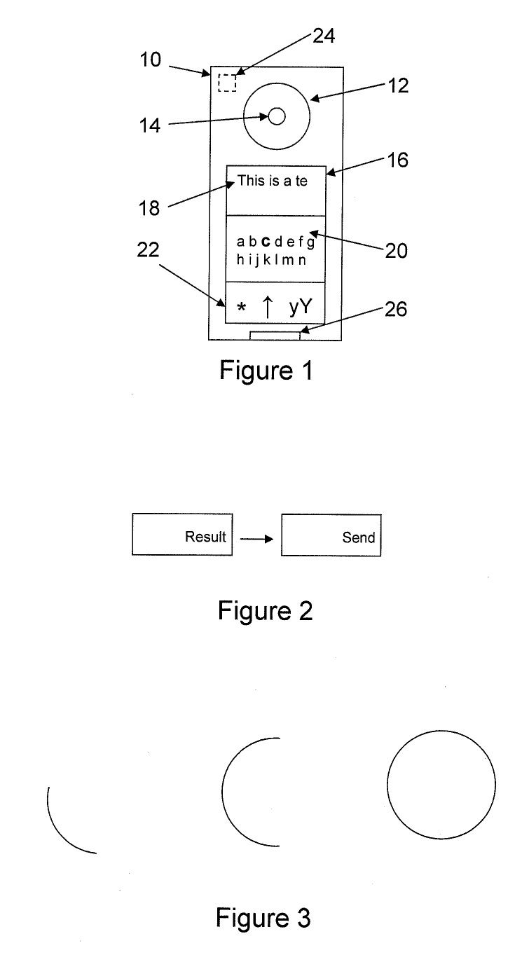

FIG. 1 illustrates the overall elements of a preferred embodiment of the invention,

FIG. 2 illustrates alternative contents of an area of the touch display, and

FIG. 3 illustrates a particular manner of informing a user of a quantity defined using the wheel.

In FIG. 1, a portable telephone 10 and/or media player with communication capabilities is illustrated. The device 10 has an input element which is a rotatable wheel 12 for a user to scroll in information (described further below) and having a centrally positioned push button 14 for a user to select a highlighted piece of information.

The device 10 may have any number of different modes or capabilities, such as media player, camera, position/route identifier (GPS capability) or the like, but that relevant to the present invention relates to the entering of a text into the device 10 for e.g. texting/SMS, e-mails or the like.

In this mode, a display 16 of the device 10 is a touch screen divided into three areas 18, 20, and 22 as will be described further below. Naturally, the display 16 may be formed of any number of displays, some or all of which may be touch sensitive.

In general, a processor indicated at 24 is provided for receiving inputs from the wheel 12, the button 14, the display 16 as well as other input elements provided, and for controlling the display 16 as well as other processes, such as the providing of media and making telephone calls/sending SMS'es/e-mails or the like.

The upper area 18 is used for illustrating a text assembled or generated so far. This text comprises any complete words as well as a word presently under generation.

The middle area 20 is used for the user to select letters, symbols, words, numbers or any other constituents of text, in any alphabet, in order to generate or select the next word of the text. Scrolling or navigating in the words/characters/symbols/letters or the like of the second area 20 is obtained by rotating the wheel 12 so as to sequentially highlight one or more of the words etc. thereof. Selection of a highlighted word/character or the like is performed by the user pushing the button 14, where after the selected word/character or the like is added to the already assembled text in the first area 18.

This addition may be at a present position of a pointer or cursor or may simply be at the end of the text (in the reading direction). Also, the addition may be a replacement, if a part of the generated text in the first area 18 has been highlighted. Then, the highlighted part in the first area 18 is replaced with the highlighted part of the second area 20. Navigation in the text of the first area 18 may be navigation between different letters or between different words, or a combination thereof where both words and individual letters therein may e.g. be individually highlighted (so as to be replaced), or positions between letters may be selected for e.g. deleting/replacing individual letters or adding letters to correct spelling errors.

In the second area 20, different types of elements, such as words, letters, numbers, symbols, or the like, may be presented as proposals for the text to be generated. As there may not be space for all such relevant elements, a part of the third area 22 has been allocated for altering between different types of elements in the second area 20. This part has the sign “*”. Touching this part will exchange the presently proposed elements (such as words) in the second area 20 with other proposed elements (such as numbers, letters, or symbols).

The third area 22 also has an area with the sign “↑”, and touching this area will replace lowercase letters in the second area 20 with uppercase letters or vice versa.

When generating a word from individual letters, for example, a dictionary may be used for providing suggestions for the final word. This is known from e.g. the T9 dictionary used in many mobile telephones today. A particular area on the display 16 may be defined for toggling the dictionary on/off.

The suggestions may be provided in the second area 20 or may be provided in the first area 18 instead of the word being generated. Toggling between individual proposals may be performed using the wheel 12 or an area of the third area 22 illustrated with the “yY” sign.

When using a dictionary, it may be desired to ensure that the text is not transmitted before there are no alternatives suggested—so that there is no doubt what the text and the message therein is. Thus, the area with the “yY” sign may convert from “result” to “send” (see FIG. 2), when the user has selected a proposed word or when the dictionary has no further alternatives for the word entered. If the user enters a word unknown to the dictionary, the area “yY” changes to “add word” so as to allow the user to add the word to the dictionary.

Toggling between navigation in the symbols/words or the like in the second area 20 and the text in the first area 18 is obtained by touching the display 16. It may be desired that this touch should be in a particular area of the display 16, such as the first area 18 or the second area 20—or in a designated portion of the display 16, or a touch of any part of the display 16 may toggle from navigation in the first area 18 to navigation in the second area 20.

In addition to the above navigation possibilities, it is desired that a particular area 26 is provided, the touching/operation of which results in a number of short cuts being presented on the display 16 to predetermined or user-defined modes of operation, such as alarm settings (for alarm clocks or the like), SMS-generation and/or a media player for e.g. playing music on the device 10.

In an interesting embodiment, a volume setting or other quantitative setting obtained using the wheel 12 is illustrated to a user by illustrating the quantity as a part of a circle corresponding to a percentage of the value compared to a maximum value. This is illustrated in FIG. 3 where approximately 25%, 50% and maximum are illustrated.

Naturally, the above wheel 12 and/or button 14 may be replaced by a touch pad as is known from the Ipod® or Iphone® for a user to touch along a closed surface to generate the same information.

Another embodiment is one relating to the operation of touch sensitive displays in general. This embodiment may be described in relation to FIG. 1, even though it is clear that the wheel/button 12/14, e.g., need not be present. Instead, selection of a word/letter/symbol/number for adding to the generated text and/or the selection of a position in the generated text on the display 16 for amendment thereof may be performed using the user's finger or a stylus.

In this context, the function or selection made or started by an area may be any function, such as the starting of an application (generate/send an e-mail, start a media player, open a folder, start a camera, GPS or the like) or during operation of an application (select a letter/word for a text being generated, take a picture, select a track to listen to).

However, as fingers normally have a large area compared to the area which is desired activated, erroneous activations may occur.

In this embodiment, a first touch on the touch display 16 will not activate or select the word/symbol/function or the like. Instead, the area touched representing a word/letter/symbol/function or the like will be highlighted, and a second touch on the same area—or a harder touch on another area (or simply on the display 16) may be taken as an indication that the originally highlighted area represents the desired operation.

Thus, the display 16 may be adapted to sense not only the position of touch but also the force thereof and be able to differ between an initial (usually lighter) touch and a harder touch.

Naturally, a number of manners exist of enabling a display 16 to be force sensitive. One is to determine an area of e.g. the finger/stylus during exertion of the two forces, where a larger area will represent a larger force.

Alternatively, the actual elements of the touch sensitive parts of the display 16 may be adapted to also quantify the force, as would be the case e.g. with certain resistive touch screens.

A further alternative is to provide force sensitive means in another position of the device 10, such as between the display 16 and a frame of the device 10—or on the frame on a surface opposite to that of the display 16 in order for the force sensor to detect the force between the device 10 and a hand holding it or a table on which the device 10 is positioned.

A still further alternative would be to provide a separate element, such as a push button (not illustrated) which the user will push when the first or initial touch was intended. Thus, the force/instruction is emulated by the entering of additional information. Until this button is pushed, no activations are performed and all touched areas are simply sequentially highlighted.

1. A method of generating a text on a handheld device having:
an element for identifying or receiving a movement along a closed curve, and
a touch sensitive display/monitor for providing information to a user, the method comprising:
1. displaying, on a first area of the display/monitor, any generated text,
2. displaying, on a second area separate from the first area, one or more proposed symbols/letters/words/characters for use in the first area,
3. upon detection of a touch of the touch sensitive display/monitor, altering between:
a. a first mode, wherein an identified/received movement causes navigation in the generated text in the first area, and
b. a second mode, wherein an identified/received movement causes one or more of the proposed symbols/letters/words/characters of the second area to be sequentially highlighted.

2. A method according to claim 1, further comprising the step of a user entering an instruction to the effect that one or more highlighted symbols/letters/words/characters in the second area is/are added to the generated text of the first area.

3. A method according to claim 1, wherein step 3 comprises detecting a touch in any of the first and second areas.

4. A method according to claim 1, wherein step 3, a, further comprises highlighting one or more words/symbols/letters/characters in the generated text and altering the generated text by altering the highlighted words/symbols/letters/characters.

5. A method according to claim 1, wherein the monitor/display comprises a third area, and wherein the method further comprises detecting a touch of the third area and altering one or more of the proposed symbols/letters/words/characters of the second area.

6. A method according to claim 1, wherein the display/monitor comprises an additional area and wherein the method further comprises:
comparing a latest added part of the generated text to words of a dictionary and proposing one or more words from the dictionary relating to the latest added part, and
detecting a touch of the additional area and transmitting the generated text to a selected recipient only if the comparing step proposes less than two words.

7. A method according to claim 1, wherein one or more proposed words is/are provided in the first area so as to replace a latest added part of the generated text.

8. A handheld device having:
an element for identifying or receiving a movement along a closed curve,
a touch sensitive display/monitor for providing information to a user, and
a processor adapted to:
1. receive signals from the identifying/receiving element and the display/monitor,
2. have the display/monitor display, on a first area thereof, any generated text,
3. have the display/monitor display, on a second area thereof separate from the first area, one or more proposed symbols/letters/words/characters for use in the first area,
4. upon detection of a touch of the touch sensitive display/monitor, alter between:
a. a first mode, wherein an identified/received movement causes navigation in the generated text in the first area, and
b. a second mode, wherein an identified/received movement causes one or more of the proposed symbols/letters/words/characters of the second area to be sequentially highlighted.

9. A device according to claim 8, wherein the processor is additionally adapted to, upon receipt of an instruction, add one or more highlighted symbols/letters/words/characters in the second area to the generated text of the first area.

10. A device according to claim 8, wherein the processor is adapted to have step 4 comprise detecting a touch in any of the first and second areas.

11. A device according to claim 8, wherein the processor is adapted to have step 4, a, further comprise highlighting one or more words/symbols/letters/characters in the generated text and altering the generated text by altering the highlighted words/symbols/letters/characters in the first area.

12. A device according to claim 8, wherein the monitor/display comprises a third area, and wherein the processor is further adapted to detect a touch of the third area and alter one or more of the proposed symbols/letters/words/characters of the second area.

13. A device according to claim 8, wherein the display/monitor comprises an additional area and wherein the processor is adapted to:
compare a latest added part of the generated text to words of a dictionary and proposing one or more words from the dictionary relating to the latest added part, and
upon detecting a touch of the additional area, transmit the generated text to a selected recipient only if the comparing step proposes less than two words.

14. A device according to claim 8, wherein the processor is adapted to provide one or more proposed words in the first area so as to replace a latest added part of the generated text.

15. A method of operating a device comprising a touch sensitive display, the method comprising:
defining one or more active areas on the display, each area being correlated to an operation of the device,
determining a first touch of an active area and highlighting the area,
determining an instruction from a user and carrying out the operation correlated to the highlighted area.

16. A method according to claim 15, wherein the first touch is a touch with an exerted first force toward the display, and wherein the instruction is a second touch of the display exerted with a second force, which exceeds the first force.

17. A method according to claim 15, wherein the instruction is a second touch of the display simultaneously to the user entering additional information.

18. A device comprising a display, the device comprising:
an element for defining one or more active areas on the display, each area being correlated to an operation of the device,
a first element for determining a first touch of an active area and for highlighting the area,
a second element for determining an instruction from a user and carrying out the operation correlated to the highlighted area.

19. A device according to claim 18, wherein the first element is adapted to identify as the first touch a touch with an exerted first force toward the display, and wherein the second element is adapted to identify as the instruction a second touch of the display exerted with a second force, which exceeds the first force.

20. A device according to claim 18, wherein the second element is adapted to identify as the instruction a second touch of the display simultaneously to the user entering additional information.
